(19) United States
(12) Patent Application Publication
(10) Pub. No.: US 2007/0298511 A1
(43) Pub. Date: Dec. 27, 2007

(54) Nanopore sensor system

(75) Inventors: Xiaofeng Kang, College Station, TX (US); Stephen Cheley, Oxford (GB); Hagan Bayley, Oxford (GB)

Correspondence Address: MEDLEN & CARROLL, LLP, Suite 350, 101 Howard Street, San Francisco, CA, 94105, US

(73) Assignee: The Texas A&M University System

(21) Appl. No.: 11/788,293

(22) Filed: Apr. 19, 2007

Related U.S. Application Data
(60) Provisional application No. 60/795,476, filed on Apr. 27, 2006.

(51) Int. Cl. G01N 27/00; B01J 13/02

(52) U.S. Cl. 436/150; 264/4.1; 422/82.01

(57) ABSTRACT

The invention relates to a nanopore sensor system including methods of fabrication and uses disclosed herein. In some embodiments, the invention relates to a substrate comprising a lipid membrane, preferably a phospholipid bilayer film, having a nanopore and a gel surrounding said lipid membrane. In additional embodiments, the invention relates to compositions and methods of using and making a substrate that has a lipid membrane having a single channel protein surrounded with a gel. In further embodiments, the invention relates to a method of detecting an analyte by mixing a nanopore sensor with a solution suspected of containing an analyte, measuring electrical properties, and correlating changes of electrical properties to the existence of an analyte.

### FIELD OF INVENTION

The invention relates to a nanopore sensor system including methods of fabrication and uses disclosed herein. In some embodiments, the invention relates to a substrate comprising a lipid membrane, preferably a phospholipid bilayer film, having a nanopore and a gel surrounding said lipid membrane. In additional embodiments, the invention relates to compositions and methods of using and making a substrate that has a lipid membrane having a single channel protein surrounded with a gel. In further embodiments, the invention relates to a method of detecting an analyte by mixing a nanopore sensor with a solution suspected of containing an analyte, measuring electrical properties, and correlating changes of electrical properties to the existence of an analyte.

### BACKGROUND

Channel proteins have been adapted in non-biological systems for sensor applications. However, because current methods of producing lipid membranes that hold channel proteins are largely comprised of non-covalent interactions, they are sensitive to environmental impact such as dehydration and mechanical disruption and degrade after a short time. In particular, most system designs are not stable to a flowing solution of analytes. Thus, there is a need to identify compositions and methods of making channel protein sensor systems that are more robust.

### SUMMARY OF INVENTION

The invention relates to a nanopore sensor system including methods of fabrication and uses disclosed herein. In some embodiments, the invention relates to a chip comprising a lipid membrane, preferably a bilayer film comprising lipids (such as phospholipids, glycolipids, etc.) having a nanopore and a gel surrounding said lipid membrane. In additional embodiments, the invention relates to compositions and methods of using and making a chip that has a lipid membrane having a single channel protein surrounded with and protected by a gel. In further embodiments, the invention relates to a method of detecting an analyte by mixing a nanopore sensor of the present invention with a solution suspected of containing an analyte, measuring electrical properties, and correlating changes of electrical properties to the existence of an analyte.

In some embodiments, the invention relates to a chip comprising a lipid membrane wherein the lipid membrane comprises a single nanopore that can be applied to measurements at the single-molecule level. In further embodiments, said chip may used in a flowing analyte solution, and is portable, storable, and reusable. In further embodiments, said chip is stable after storage for at least three weeks. In further embodiments, said chip containing a single M113R/T147R α-hemolysin pore can be used for the single molecule sensing of inositol 1,4,5-triphosphate.

In some embodiments, the invention relates to a device comprising a lipid membrane comprising a single nanopore and a gel configured to surround said lipid membrane.

In some embodiment, the invention relates to a chip comprising a middle layer sandwiched between two outer layers; wherein said middle layer comprises an inner orifice containing a lipid membrane comprising a nanopore surrounded by a gel and said two outer layers both comprise outer orifices configured to surround said lipid membrane with said gel.

In additional embodiments, the invention relates to a chip consisting essentially of a middle layer sandwiched between two outer layers; wherein said middle layer comprises an inner orifice containing a lipid membrane comprising a nanopore surrounded by a gel and said two outer layers both comprise orifices configured to surround said lipid membrane with said gel. In further embodiments, said lipid membrane consists of a single nanopore. In further embodiments, said nanopore is an alpha HL protein. In further embodiments, said alpha HL protein is alpha HL-M113R/T147R (_{PRR-2}). In further embodiments, said lipid membrane is a phospholipid bilayer. In further embodiments, said phospholipid bilayer comprises 1,2-diphytanoyl-sn-glycero-3-phosphatidylcholine. In further embodiments, said middle layer is polytetrafluoroethylene. In further embodiments, said gel is a polysaccharide based gel. In further embodiments, said polysaccharide based gel comprises agarose and chitosan.

In some embodiments method of creating a gel covered lipid membrane on a substrate comprising: a) providing: i) a substrate (such as a chip) comprising a first orifice, a first side, and a second side; ii) a solution having a surface and a first temperature comprising a component for making a gel; and iii) a lipid; b) contacting said lipid and said solution under conditions such that said lipid is floating on the surface of said solution; and c) contacting said first orifice with said lipid under conditions such that a lipid membrane is formed inside said first orifice between said first side and said second side of said substrate and said solution surrounds said lipid; and d) modifying said solution under conditions such that said component for making a gel forms a gel. In further embodiments, the method further comprises the steps of e) adding a nanopore to said solution; and f) applying a voltage between said lipid membrane under conditions such that a lipid membrane comprising said nanopore is formed. In further embodiments, modifying said solution under conditions such that said component for making a gel forms a gel is cooling said solution to a second temperature below said first temperature. In further embodiments, said lipid membrane consists of a single nanopore. In further embodiments, said nanopore is an alpha HL protein. In further embodiments, said alpha HL protein is alpha HL-M113R/T147R (_{PRR-2}). In further embodiments, said lipid membrane is a phospholipid bilayer. In further embodiments, said phospholipid bilayer comprises 1,2-diphytanoyl-sn-glycero-3-phosphatidylcholine. In further embodiments, said gel is a polysaccharide based gel. In further embodiments, said gel component comprises agarose and chitosan.

In some embodiments, the invention relates to a method of detecting an analyte comprising: a) contacting substrates and devices disclosed herein with a solution suspected of containing an analyte, b) measuring electrical properties, and c) correlating changes of electrical properties to the existence of an analyte.

In additional embodiments the invention relates to a method for sensing at least one analyte in a sample comprising: i) providing a) an analyte in a sample b) a chip comprising a sensor element having a receptor site a nanopore coupled to the receptor site disposed in a lipid membrane and a gel surrounding said lipid membrane and ii) interacting the sample with said chip, in manner that allows interaction of the analyte with the receptor site to produce a signal.

In some embodiments, the invention relates to a method of creating a gel covered lipid membrane on a substrate (such as on a chip) comprising: a) providing: i) a substrate comprising a first orifice, a first side, and a second side; ii) a solution having a surface and a first temperature comprising a component for making a gel; and iii) a lipid; b) contacting said solution with said substrate in a configuration such that said surface and said first orifice are proximal; d) contacting said lipid and said solution under conditions such that said lipid is floating on the surface of said solution; and e) contacting said first orifice with said lipid under conditions such that a lipid membrane is formed inside said first orifice between said first side and said second side of said substrate and said solution is in contact with said lipid; and f) cooling said solution to a second temperature below said first temperature under condition such that said component for making a gel forms a gel. In some embodiments, the method further comprises the steps of h) adding a nanopore to said solution; and i) applying a voltage between said lipid membrane under conditions such that a lipid membrane comprising said nanopore is formed. In further embodiments, said gel is a polysaccharide based gel. In further embodiments, said polysaccharide based gel comprises agarose and chitosan. In one embodiment, said first orifice is positioned such that the gel surrounds and protects the lipid membrane. In further embodiments, said chip is made of first polymer comprising a first orifice sandwiched between a second polymer and a third polymer, said second and third polymers both contain a second orifice larger than said first orifice configured such that a cavity is formed on each side of said first polymer comprising said first orifice. In further embodiments, said first polymer is different from said second and third polymers. In further embodiments, said first side and said second side comprise an uneven surface proximal to said first orifice. In further embodiments, said uneven surface is configured to hold a gel in contact with said lipid membrane. In some embodiments, the method further comprises the step of storing said chip in an atmosphere below room temperature.

In some embodiments, the invention relates to a chip comprising: two outer layers and a middle layer, said middle layer comprises an inner orifice comprising a phospholipid bilayer film orientated in the direction of the layer having a nanopore; the outer layers both contain orifices filled with gel configured such that the bilayer film is surrounded by gel in order to protect the phospholipid bilayer from mechanical disruption. In preferred embodiments, said inner orifice is smaller than said orifices of the outer layers such that a portion of the middle layer near the orifice is surrounded by gel, i.e., the orifices of the outer layers are configure to create a compartment near the inner orifice for holding the gel.

In some embodiments, the invention relates to a substrate such as a chip comprising a first side and a second side and a first orifice wherein said first orifice comprises a lipid membrane comprising a nanopore and wherein said first side and said second side comprise a surface proximal to said first orifice configured to hold a gel in contact with both sides of said lipid membrane. It is not intended that embodiments of the present invention be limited by the size, positioning or shape of a particular orifice. Preferably, the diameter is between 100 and 10 μM and even more preferably the diameter is smaller as long as it is sufficient to contain a lipid membrane comprising a single nanopore. In general, the shape may be circular. In further embodiments, said chip is made of a first polymer having said first orifice sandwiched between a second polymer and a third polymer, said second and third polymers both containing an orifice larger than said first orifice configured such that said surface is a cavity formed on each side of said first polymer proximal to said first orifice. In further embodiments, said first polymer is different from said second and third polymer. In further embodiments, said lipid membrane, distinct from said first polymer, second, polymer and third polymer, is a lipid bilayer. In further embodiments, said lipid membrane comprises one or more phospholipids such as 1,2-diphytanoyl-sn-glycero-3-phosphatidylcholine. In further embodiments, said first polymer is polytetrafluoroethylene. In further embodiments, said lipid membrane comprises a single nanopore. It is not intended that the present invention be limited to a particular nanopore. In further embodiments, said nanopore is a channel protein. When a channel protein is employed, a variety of proteins can be selected. In further embodiments, said channel protein is an alpha HL protein. In further embodiments, said alpha HL protein is alpha HL-M113R/T147R (_{PRR-2}). In further embodiments, said gel is a polysaccharide based gel. In further embodiments, said polysaccharide based gel comprises agarose and chitosan.

In further embodiments, the invention relates to a device comprising a chamber having a barrier creating a first compartment and a second compartment within said chamber, wherein said barrier comprising a first side and a second side and a first orifice comprising a lipid membrane comprising a nanopore is configured in said chamber such that said first compartment is exposed to said first side and said second compartment is exposed to said second side, and wherein said first side and said second sides both comprise an surface proximal to said first orifice configured to hold a gel in contact with said lipid membrane. In further embodiments, said barrier is made of first polymer comprising an first orifice sandwiched between a second polymer and a third polymer, said second and third polymers both contain an orifice larger than said first orifice configured such that a cavity is formed on each side of said first polymer comprising said first orifice. In further embodiments, said first polymer is different from said second and third polymer. In further embodiments, said lipid membrane is a lipid bilayer. In further embodiments, said lipid membrane comprises one or more phospholipids such as 1,2-diphytanoyl-sn-glycero-3-phosphatidylcholine. In further embodiments, said first polymer is polytetrafluoroethylene. In further embodiments, said nanopore is a channel protein. In further embodiments, said channel protein is an alpha HL protein. In further embodiments, said alpha HL protein is alpha HL-M113R/T147R (_{PRR-2}). In further embodiments, said gel is a polysaccharide based gel. In further embodiments said polysaccharide based gel comprises agarose and chitosan.

In additional embodiments, the invention relates to a device comprising: a) a chamber configured to hold a removable barrier creating a first compartment and a second compartment within said chamber and b) a barrier separate from said chamber comprising a first side and a second side, and an orifice comprising a lipid membrane comprising a nanopore configured to be placed in said chamber such that said first compartment is exposed to said first side and said second compartment is exposed to said second side. In other embodiments, the device further comprises a first electrode and a first electrolyte solution and a second electrode and a second electrolyte solution wherein said first compartment comprises said first electrode and said first electrolyte solution and said second compartment comprises said second electrode and said second electrolyte solution. In other embodiments, the device further comprises a thermal unit configured to control the temperature of said chamber. In further embodiments, said first side and said second side comprise a surface proximal to said orifice. In further embodiments, said surface is configured to hold a gel in contact with said lipid membrane. In some embodiments, the device further comprises a thermal unit configured to control the temperature of said chamber. It is not intended that any particular thermal unit be used or that it be placed in any particular area. In a preferred embodiment the thermal unit is attached to the bottom of the chamber. In further embodiments, said nanopore is a channel protein. In further embodiments, said channel protein is an alpha HL protein. In further embodiments, said alpha HL protein is alpha HL-M113R/T147R (_{PRR-2}).

In some embodiments, the invention relates to a method of detecting an analyte comprising a) providing i) a device comprising a chamber having a barrier creating a first compartment and a second compartment within said chamber, wherein said barrier comprising a first side and a second side and an orifice comprising a lipid membrane comprising a nanopore is configured in said chamber such that said first compartment is exposed to said first side and said second compartment is exposed to said second side, and wherein said first side and said second side comprise a surface proximal to said orifice holding a gel coating said lipid membrane; ii) a first electrode and a second electrode configured between said orifice; and iii) a solution suspected of containing an analyte wherein said nanopore has an affinity for or selectively binds said analyte; b) contacting said solution suspected of containing an analyte with said gel coating said lipid membrane; c) applying a voltage between said first and second electrode; d) measuring the movement of electrons; and e) correlating changes in the movement of electrons to the existence of said analyte. In further embodiments, said gel is a polysaccharide based gel. In further embodiments, said polysaccharide based gel comprises agarose and chitosan. It is not intended that the invention be limited to the use of any particular gel. In general, polysaccharide and polyacrylamide gels can be used. In further embodiments, said nanopore is a channel protein. In further embodiments, said channel protein is an alpha HL protein. In further embodiments, said alpha HL protein is alpha HL-M113R/T147R (_{PRR-2}). In further embodiments, said analyte is inositol 1,4,5-triphosphate. In further embodiments, measuring the movement of electrons comprises measuring current between the first and second electrodes. In further embodiments, correlating the changes in the movement of electrons to the existence of said analyte comprises observing a change in current as corresponding to the presence of the analyte. In further embodiments, correlating the changes in the movement of electrons to the existence of said analyte comprises observing no change in current as corresponding to the absence of the analyte.

In some embodiments, the invention relates to a method of detecting the presence of an analyte in a sample, the method comprising: contacting said sample with a pore assembly comprising one or more pore-subunit polypeptides sufficient to form a pore within a lipid membrane surrounded by a gel, wherein the pore comprises at least a first channel, and at least one of said pore-subunit polypeptides is a modified pore-subunit polypeptide comprising a pore-subunit polypeptide covalently linked to an exogenous sensing moiety capable of preferentially binding with a specific analyte; and detecting an electrical current through at least a first channel, wherein a modulation in current compared to a current measurement in a control sample lacking said analyte indicates the presence of said analyte in said sample.

In some embodiments, the invention relates to a method of detecting the presence of an analyte in a sample, wherein the analyte comprises a polynucleic acid comprising a specific base sequence, the method comprising: contacting said sample with a pore assembly comprising one or more pore-subunit polypeptides sufficient to form a pore within a lipid membrane surrounded by a gel, wherein the pore comprises at least a first channel, and at least one of said pore-subunit polypeptides is a modified pore-subunit polypeptide comprising a pore-subunit polypeptide covalently linked to an exogenous sensing moiety that is an oligonucleotide, wherein the oligonucleotide comprises a base sequence that is complementary to said specific base sequence of said analyte; and detecting an electrical current through at least a first channel, wherein a modulation in current compared to a current measurement in a control sample lacking said analyte indicates the presence of said analyte in said sample.

### BRIEF DESCRIPTION OF THE FIGURES

FIGS. 1A and 1B shows one embodiments of the protein channel sensor chip (not to scale). The Teflon film (2) having an inner orifice (5) of 100 μM diameter (7) sandwiched between two polymer films (1) and (3) both having an outer orifice (4) of 200 μM diameter (6).

FIG. 2 shows an illustrative schematic diagram (not to scale) of the chip containing the protein channel: (a) top view and (b) side view.

FIG. 3. An embodiment of the invention showing a device comprising a chamber (8) having a barrier (9) creating a first compartment (10) and a second compartment (11) within said chamber, wherein said barrier comprising a first side (12) and a second side (13) and a first inner orifice (5) comprising a lipid membrane comprising a nanopore is configured in said chamber such that said first compartment is exposed to said first side and said second compartment is exposed to said second side, and wherein said first side and said second sides both comprise an outer surface (4) proximal to said first orifice configured to hold a gel in contact with said lipid membrane comprising a first electrode (14) and a second electrode (15).

FIG. 4. The embodied apparatus consists of a designed Teflon block, a stainless steel stand, and a Peltier device. The block contains two chambers, designated cis and trans. The planar lipid bilayer is formed across a 100-150 μm-diameter orifice in a 25 μm thick Teflon film that separates the two chambers. The bigger cylindrical holes (diameter=5 mm), which are connected to the main chambers, are used for holding the electrodes. The smaller holes (diameter=1.5 mm) are used for holding a thermocouple, the tip of which is exposed to the electrolyte and therefore accurately monitors the temperature in the main chamber. The two chambers are clamped tightly together in a holder made of stainless steel. The bottoms of the chambers were covered with a single thin sheet of borosilicate glass (0.16 mm thick) for efficient heat transfer between the solution in the chambers and the surface of the Peltier device. The Peltier device and the chambers are mounted on a stainless steel stand, which provides efficient heat dissipation during cooling. The temperature in the chamber was controlled by varying the current through the Peltier device with a DC power supply.

FIG. 5. The current recordings and all-points histograms made during the process of forming the protein channel chip.

FIGS. 6A and 6B. A representative response of a single protein nanopore sensor chip when exposed to a solution of the molecule inositol 1,4,5-trisphosphate (IP₃) in 0.1M Tris buffer (pH 7.4), 1 M NaCl. Trace in FIG. 5A is before exposure to solution of analyte and trace in FIG. 5B is recorded after 2 minutes when addition 0.6 μM IP₃ to the cis chamber.

### DETAILED DESCRIPTION OF THE INVENTION

The invention relates to a nanopore sensor system including methods of fabrication and uses disclosed herein. In some embodiments, the invention relates to a chip comprising a lipid membrane, preferably a phospholipid bilayer film, having a nanopore and a gel surrounding said lipid membrane. In additional embodiments, the invention relates to compositions and methods of using and making a chip that has a lipid membrane having a single channel protein surrounded with a gel. In further embodiments, the invention relates to a method of detecting an analyte by mixing a nanopore sensor with a solution suspected of containing an analyte, measuring electrical properties, and correlating changes of electrical properties to the existence of an analyte.

As used herein, the term “analyte” refers to a substance or chemical constituent that is undergoing analysis or sought to be detected. It is not intended that the present invention be limited to a particular analyte. Representative analytes include ions, saccharides, proteins, nucleic acids and nucleic acid sequences.

In preferred embodiments, nanopores are fabricated on substrates such as chips, disks, blocks, plates and the like. Such substrates can be made from a variety of materials including but not limited to silicon, glass, ceramic, germanium, polymers (e.g. polystyrene), and/or gallium arsenide. The substrates may or may not be etched, e.g. chips can be semiconductor chips.

The term “sandwiched” as used in relation to a material means to insert between two other materials. It is not intended for the purpose herein that that the central material be different than the outer materials or that the outer material be the same material. In a preferred embodiment, Teflon (polytetrafluoroethylene) is sandwiched between two polymers.

As used herein, the term “chamber” means a structure to confine matter to an area. The chamber may have one or more openings and, it is not intended to be limited to entirely enclosed space.

As used herein, the term “compartment” means one of the spaces into which an area is subdivided.

As used herein, the term “orifice” means an opening or hole. The present invention is not limited to particular sizes; however, preferred sizes are between 200 and 10 μM. A variety of shapes and positions can be employed. In certain embodiments, layers of a device contain orifices of varying size. The designation of an “inner” or “outer” orifice describes the layers that contain the orifice. For example, an inner layer may contain an orifice that is smaller than outer orifices contained in outer layers that are in contact with the inner layer. The outer orifices and the inner orifice of the inner and outer layers may be positioned proximal to each other in order to create a continuous opening through the device wherein a lipid membrane may be placed.

As used herein, the term “lipid membrane” means a film made primarily of compounds comprising saturated or unsaturated, branched or unbranched, aromatic or non-aromatic, hydrocarbon groups. The film may be composed of multiple lipids. In a preferred, embodiment the lipid is 1,2-diphytanoyl-sn-glycero-3-phosphatidylcholine. Other examples of lipids include, but are not limited to, fatty acids, mono-, di-, and tri-glycerides, glycerophospolipids, sphingolipids, steroids, lipoproteins and glycolipids.

The term “floating” as use in reference to a lipid on a solution means that the lipid is bore up by, i.e., buoyed, by the solution. It is not intended that the present invention be limited to the degree to which the lipid is buoyed by the solution. For example, the lipid may be partly or largely submerged. As a lipid is hydrocarbon based, i.e. oil based, lipids are not attracted to molecules that have hydroxyl groups, e.g., water. Thus, lipids do not mix with aqueous based solutions, and typically form a film “floating” on the top of the solution (provided they are of the right density). In some embodiments and with regard to particular phospholipids, in a water-based solution the polar “phospho” head moiety will interact with the hydrophilic solution while the non-polar “lipid” tail moieties form a monolayer of lipids. Bending the surfaces of these solutions in the appropriate fashion will cause a lipid bilayer film to form. In a preferred embodiment, the lipid bilayer film forms in a hole of a polytetrafluoroethylene barrier while the aqueous solution continues to surround the water-soluble polar head moieties.

As used herein, the terms “nanopore” and “channel” are used to refer to structures having a nanoscale passageway through which ionic current can flow. The inner diameter of the nanopore may vary considerably depending on the intended use of the device. Typically, the channel or nanopore will have an inner diameter of at least about 0.5 nm, usually at least about 1 nm and more usually at least about 1.5 nm, where the diameter may be as great as 50 nm or longer, but in many embodiments will not exceed about 10 nm, and usually will not exceed about 2 nm.

The nanopore should allow a sufficiently large ionic current under an applied electric field to provide for adequate measurement of current fluctuations. As such, under an applied electric field of 20 mV in the presence of pH 7.5 buffered solution (as described in the experimental section, infra), the open (i.e. unobstructed) nanopore should provide for an ionic current that is at least about 1 pA, usually at least about 10 pA and more usually at least about 100 pA. Typically, the ionic current under these conditions will not exceed about 0.5 nA and more usually will not exceed about 1 nA. In addition, the channel should provide for a stable ionic current over a relatively long period of time. Generally, channels finding use in the subject devices provide for accurate measurement of ionic current for at least about 1 min, usually at least about 10 min and more usually at least about 1 hour, where they may provide for a stable current for as long as 24 hours or longer.

The nanopore that is inserted into the lipid bilayer may be a naturally occurring or synthetic nanopore. Typically the nanopore will be a proteinaceous material, by which is meant that it is made up of one or more, usually a plurality, of different proteins associated with each other to produce a channel having an inner diameter of appropriate dimensions, as described above. It is not intended to be limited to any particular ion channel and pore protein. Suitable channels or nanopores include porins, gramicidins, and synthetic peptides. Of particular interest is the heptameric nanopore or channel produced from alpha-hemolysin (HL), particularly alpha-hemolysin from Staphylococcus aureus, where the channel is preferably rectified, by which is meant that the amplitude of the current flowing in one direction through the channel exceeds the amplitude of the current flowing through the channel in the opposite direction. In an even more preferred embodiment, the channel protein is a biologically engineered alpha HL protein. By making amino acid modifications, alpha HL has been engineered to allow the sensing of metal ions in Braha et al., Chem. Biol. 4, 497-505 (1997) and Braha et al., Nat. Biotechnol. 17, 1005-1007 (2000) organic molecules in Gu et al., Nature 398, 686-690. 1999), saccharides in Cheley et al., Chemistry & Biology, Vol. 9, 829-838, (2002), DNA in Howorka et al., Nat. Biotechnol. 19, 636-639 (2001), and proteins in Movileanu et al, in Nat. Biotechnol. 18, 1091-1095.

As used herein, the term “selective binding” refers to the binding of one material to another in a manner dependent upon the presence of a particular molecular structure (i.e., specific binding). For example, an immunoglobulin will selectively bind an antigen that contains the chemical structures complementary to the ligand binding site(s) of the immunoglobulin. This is in contrast to “non-selective binding,” whereby interactions are arbitrary and not based on structural compatibilities of the molecules.

A “surface proximal to an orifice” means that the surface is near the orifice. In a preferred embodiment, a portion of the surface near but some distance from the edge of the orifice is raised in relation to the orifice to form a defined space. In preferred embodiments, the edge of the orifice is circular and the raised surface around the edge forms a bowl shape. As this area is used to hold gel in contact with a lipid membrane within the orifice, the exact shape of the holding area is not critical. Therefore, it is not intended that the space created by an uneven surface be limited to any particular shape.

Detecting analytes using channel proteins is described in U.S. Pat. Nos. 6,927,070, 6,916,665 (describing modified pore-subunit polypeptide comprising a pore-subunit polypeptide covalently linked to an exogenous sensing moiety capable of preferentially binding with a specific analyte), U.S. Pat. Nos. 6,919,002 and 6,746,594, all hereby incorporated by reference. Nucleic acid sequencing using nanopores is described in U.S. Pat. No. 7,005,264 hereby incorporated by reference.

In some embodiments, the invention relates to channel proteins assembled into a lipid bilayer membrane. The presence of an analyte is monitored by the ionic current that passes through the pore at a fixed applied potential with an interruption of current indicating interactions of the analyte with the channel protein. In some embodiments, a stabilized sensor chip contains a single protein nanopore protein. The protein nanopore sensor chip can be applied to measurements at the single-molecule level, i.e. stochastic sensing. The protein nanopore chip is robust and stable for at least three weeks, preferably is stable for 3 months, and even more preferably stable for a year if stored below 5° C. and is portable so that it may be reused. The chip can be used to detect an analyte in a flowing analyte solution. And the chip can be use for the detection of low concentrations of organic molecules at a single molecular level as illustrated by the detection of inositol 1,4,5-triphosphate provided below. Engineered versions of transmembrane protein pores can be used as stochastic sensing elements for the identification and quantification of a wide variety of analytes at the single-molecule level. See e.g., Guan et al., ChemBioChem 6(10): 1875-1881 (2005). By monitoring the ionic current that passes through the pore at a fixed applied potential, various analytes can be distinguished on the basis of the amplitude and duration of individual current-blocking events. Detailed methods for making and analyzing single protein pores are described in Kang et al., Angew. Chem. Int. Ed. 44: 1495-1499 (2005) and its supporting information.

As used herein, a “gel” means an apparently solid, jelly-like material. By weight, gels are mostly liquid, yet they behave like solids. In general, gels are made up of components that provide semi-rigid structure and readily absorb liquids. Examples are agarose and polyacrylamide gels. In preferred embodiments, the gel is formed as a polymer of saccharides, i.e., polysaccharide based gel. Examples include agarose and chitosan gels. Preferred gels are water-absorbent yet prevent quick evaporation and dehydration. With regard to references that the gel “surround” a lipid membrane the gel is meant to act as a protective barrier but yet allow the passage of analytes that may be a solution; thus, the analytes may be absorbed and pass through the pores of the gel before contacting the surrounded lipid membrane.

Modifying a solution under conditions such that a gel is formed can be accomplished by a variety of methods. In a preferred embodiment, the gel forms because a saccharide solution is heat and then cooled. The heating process causes the saccharide to form a gel on cooling. Gels are made using substances (gelling agents) that undergo a degree of cross-linking or association when hydrated and dispersed in the dispersing medium, or when dissolved in the dispersing medium. This cross-linking or association of the dispersed phase will alter the viscosity of the dispersing medium. The movement of the dispersing medium is restricted by the dispersed phase, and the viscosity is increased. There are many gelling agents. Some of the common ones are acacia, alginic acid, bentonite, Carbopols® (now known as carbomers), carboxymethylcellulose. ethylcellulose, gelatin, hydroxyethylcellulose, hydroxypropyl cellulose, magnesium aluminum silicate (Veegum®), methylcellulose, poloxamers (Pluronics®), polyvinyl alcohol, sodium alginate, tragacanth, and xanthan gum. Polymers of primarily beta 1,4-galacturonans (polygalacturonans) also called homogalacturons (HGA) and are common in gels. Divalent cations, like calcium, form cross-linkages to join adjacent polymers creating a gel. Pectic polysaccharides can also be cross-linked by dihydrocinnamic or diferulic acids.

Agarose Gel Protection of Lipid Bilayers

The use of an agarose hydrogel layer to protect a lipid bilayer from dehydration and mechanical disruption was reported in Uto et al., Anal Science 10:943-946 (1994) and Tien & Ottova Electrochim Acta 43:3587-3610 (1998). However, the bilayer supported on a gel substrate is still directly exposed on one face to an aqueous electrolyte and cannot withstand the removal of electrolyte or mechanical disruption. Gel layers used to protect both sides of the lipid bilayer was studied for diffusion of receptor substrates through the supporting gel layer in Beddow et al., Anal Chem 76:2261-2265 (2004). This method primarily consist of forming a bottom pre-formed gel, placing a poly(tetrafluoroethylene) layer on the bottom gel layer with a opening for forming the lipid bilayer, and covering the lipid bilayer with a pre-formed gel layer having an opening for providing proteins or solutions to access the top of the gel. Production reproducibility using this method is poor, and the high level of current noise prevents sensor detection using single protein channel conductance values.

In embodiments, the invention relates to a method where a lipid bilayer is formed on a platform (i.e. on a chip) and a single protein nanopore is inserted into it while the agarose is in a solution state at an elevated temperature. After cooling and the formation of a gel in the chamber, the chip is cut out of the gel in such a way that a thin protective layer remains over the lipid bilayer. The sandwich nanopore chip can readily be removed form the chamber. The chip is storable and portable, and can be reassembled into the recording chamber. The conductance of a single nanopore in the sandwich chip is similar to an unprotected lipid bilayer.

### EXPERIMENTAL

### Example 1

### Protein Pore Chip

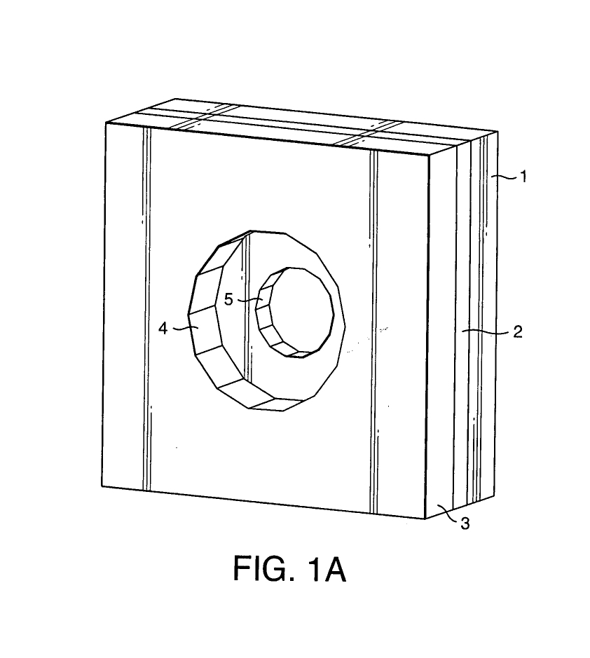

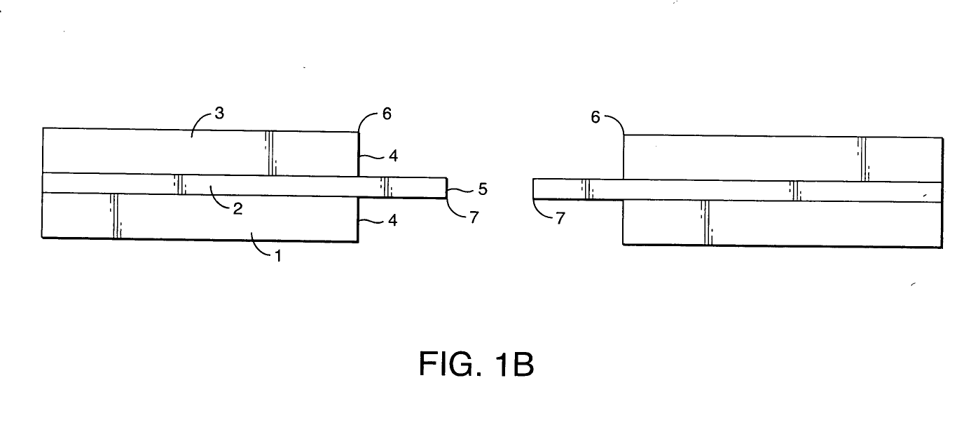

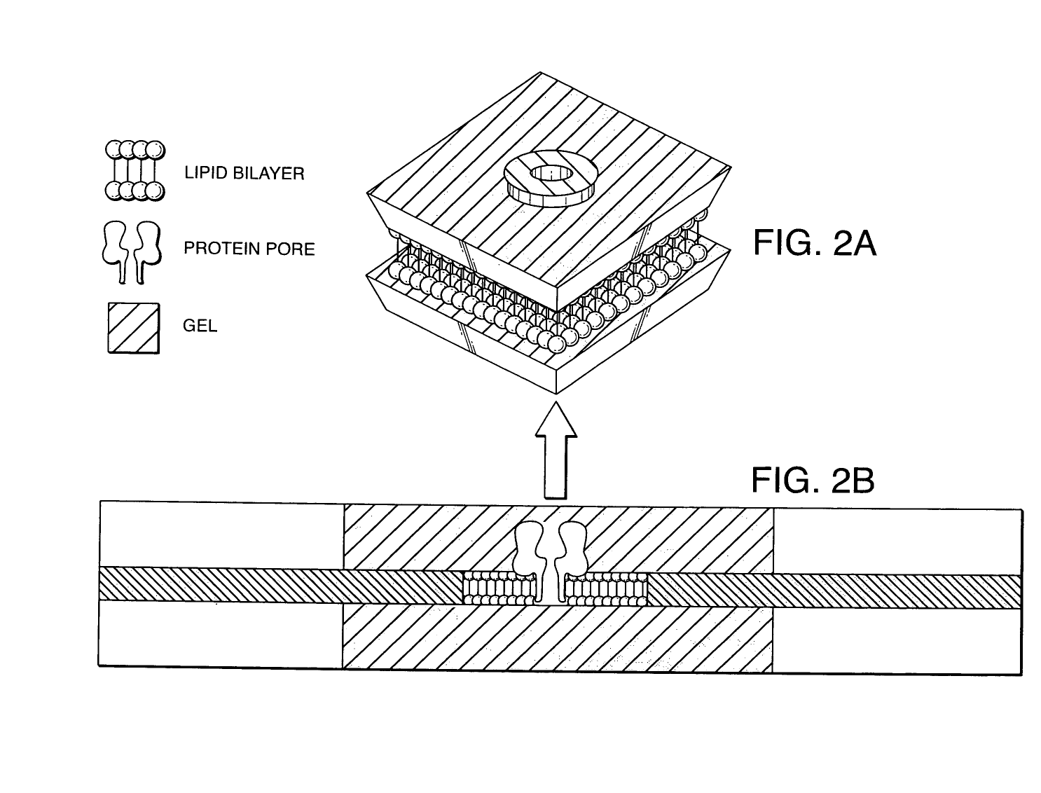

A 25 μm thick Teflon septum with a 100 μm diameter orifice was sandwiched between two 200 μm thick polyester films with a 0.2 cm diameter orifice to form a three-layer chip (FIGS. 1A and 1B). The lipid bilayer is formed across the 100 μm diameter orifice and a protein channel, for example, alpha-hemolysin, inserts itself into the bilayer. The two larger orifices are used for trapping the polymer gel that protects the bilayer from mechanical disturbance and from drying out. The protein channel chip is a sandwich chip in which a single protein channel in a lipid bilayer membrane is protected on both faces by a polymer gel.

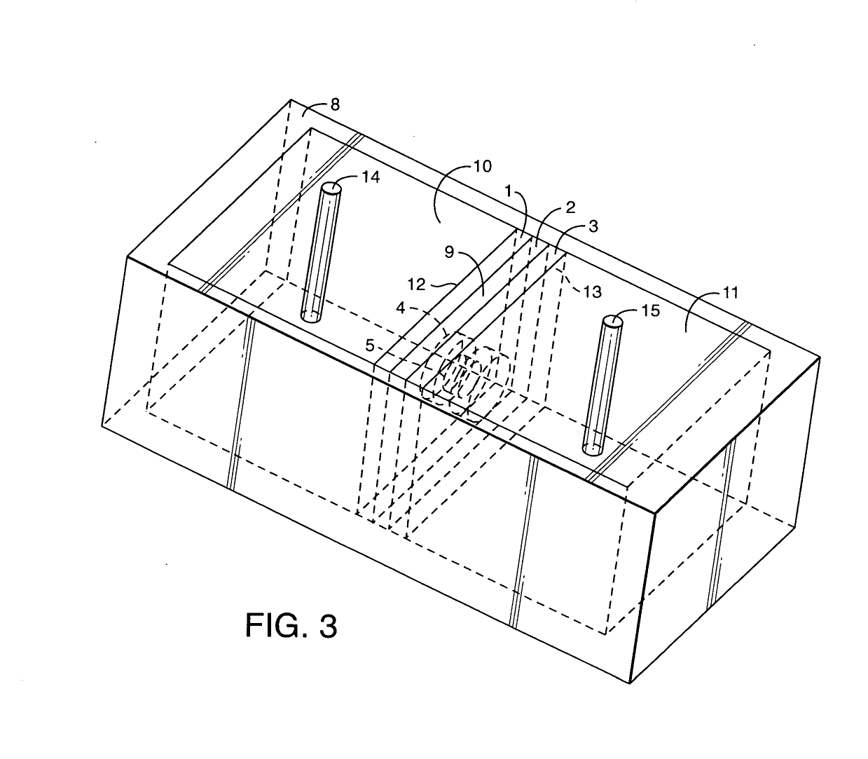

The preparation of the gel-protected protein nanopore chip and electrical recordings were carried out in a specially designed heating/cooling chamber. The apparatus consists of a specially designed Teflon block that is configured to hold the protein channel chip, a stainless steel stand, and a Peltier device (FIG. 3). The block contains two chambers, designated cis and trans. The planar lipid bilayer is formed across a 100-150 μm-diameter orifice in a 25 μm thick Teflon film that separates the two chambers. The bigger cylindrical holes (diameter=5 mm), which are connected to the main chambers, are used for holding the electrodes. The smaller holes (diameter=1.5 mm) are used for holding a thermocouple, the tip of which is exposed to the electrolyte and therefore accurately monitors the temperature in the main chamber. The two chambers are clamped tightly together in a holder made of stainless steel. The bottoms of the chambers were covered with a single thin sheet of borosilicate glass (0.16 mm thick) for efficient heat transfer between the solution in the chambers and the surface of the Peltier device. The Peltier device and the chambers are mounted on a stainless steel stand, which provides efficient heat dissipation during cooling. Varying the current through the Peltier device with a DC power supply controlled the temperature in the chamber.

The 100 μm diameter orifice in the Teflon film is pretreated with a 1:10 solution of hexadecane/pentane mixture. The sandwich chip is place in the temperature-controlled chamber. A warm solution (45° C.) containing 1.5% agarose, 1% chitosan in 0.75 mL of 0.1 M Tris (tris(hydroxymethyl)aminomethane) buffer (pH 7.4) and 1 M NaCl is added to each side of the chamber. At this point, the solution level is below the 0.2 cm-diameter aperture on the polymer film. The temperature of the chamber is maintained at 45 C to keep the solution in a liquid state. 1,2-diphytanoyl-sn-glycero-3-phosphatidylcholine (DPhPC) (20 μL, 1% in pentane) was transferred to each side of the chamber and allowed to spread on the surface of the solution. After about 2 minutes, during which the pentane evaporated, additional warm 1.5% agarose, 1% chitosan in 0.1 M Tris buffer (pH 7.4), 1 M NaCl (45 C) was added to each side allowing the solution level to rise above the 0.2 cm-diameter aperture in the polymer film. The formation of a lipid bilayer on the Teflon aperture was verified by observing increased capacitance of the membrane to a value of approximately 8-10 fF μm⁻².

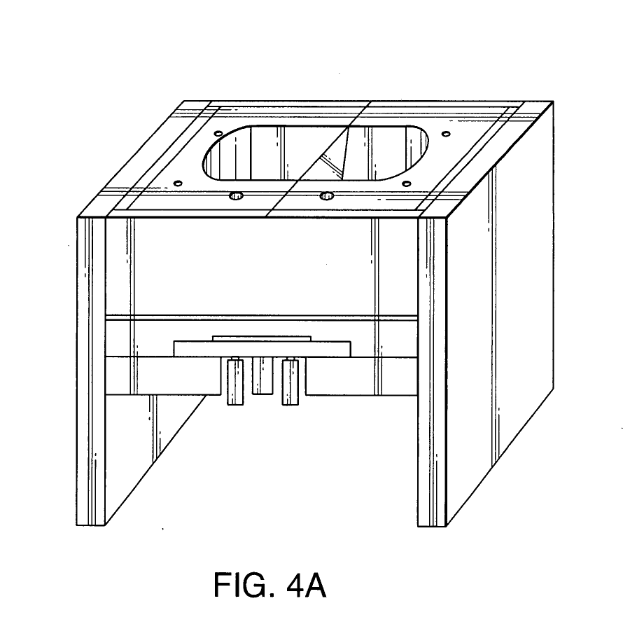

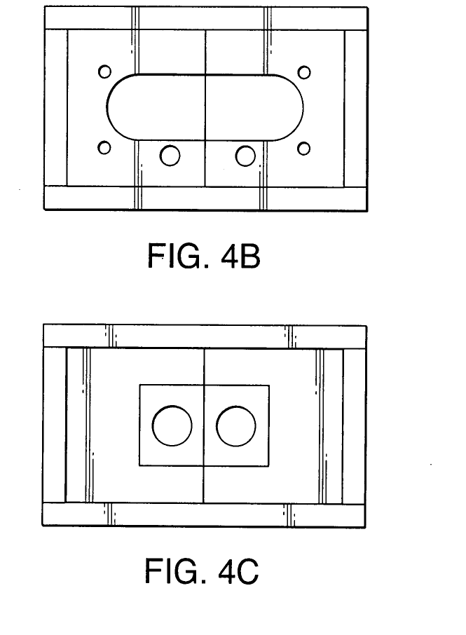

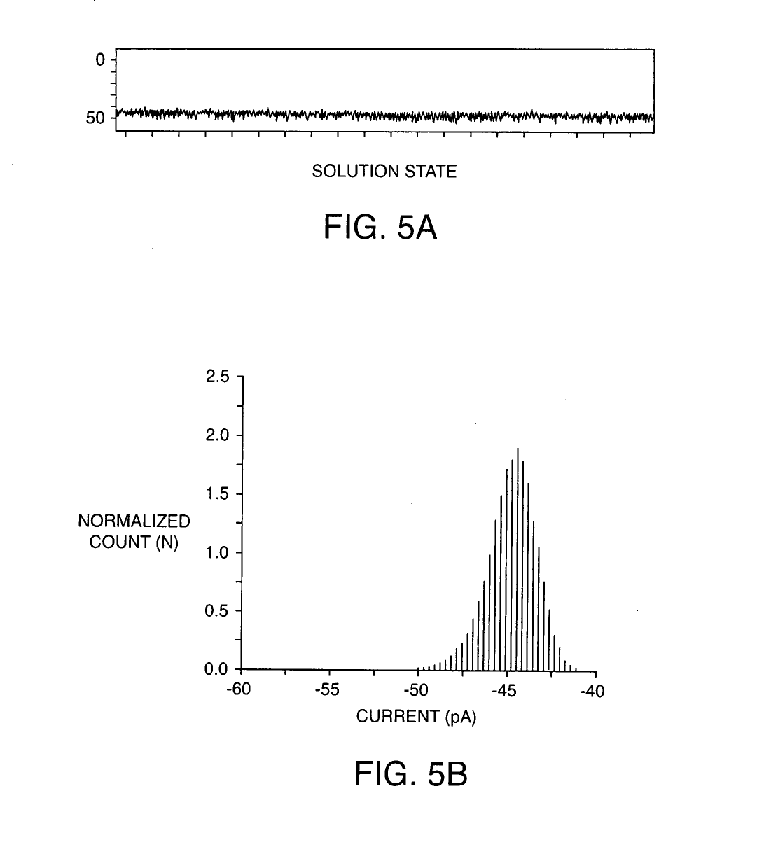

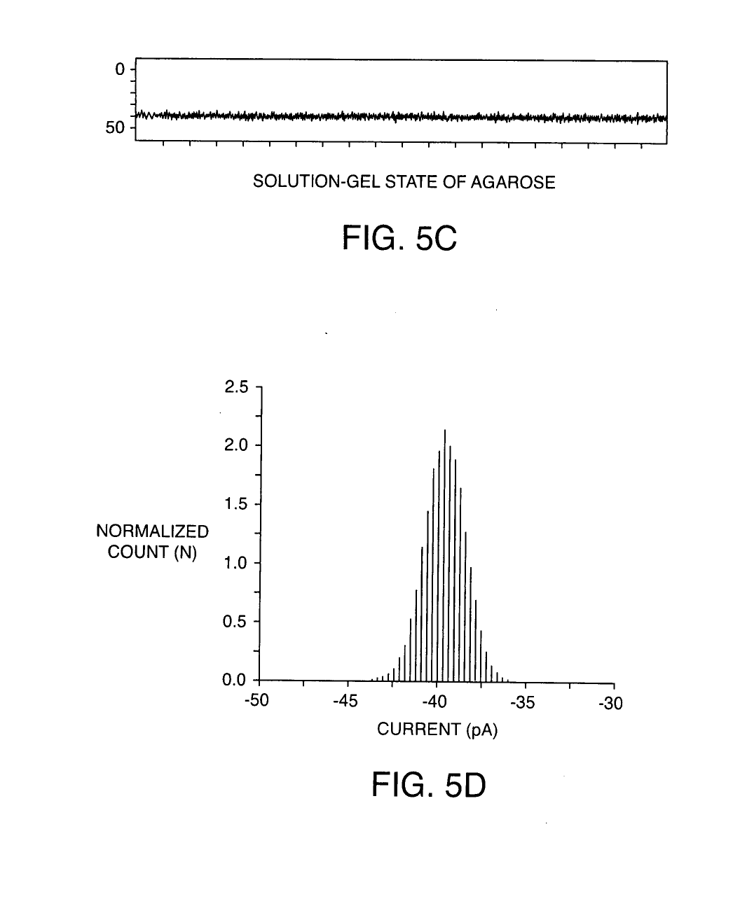

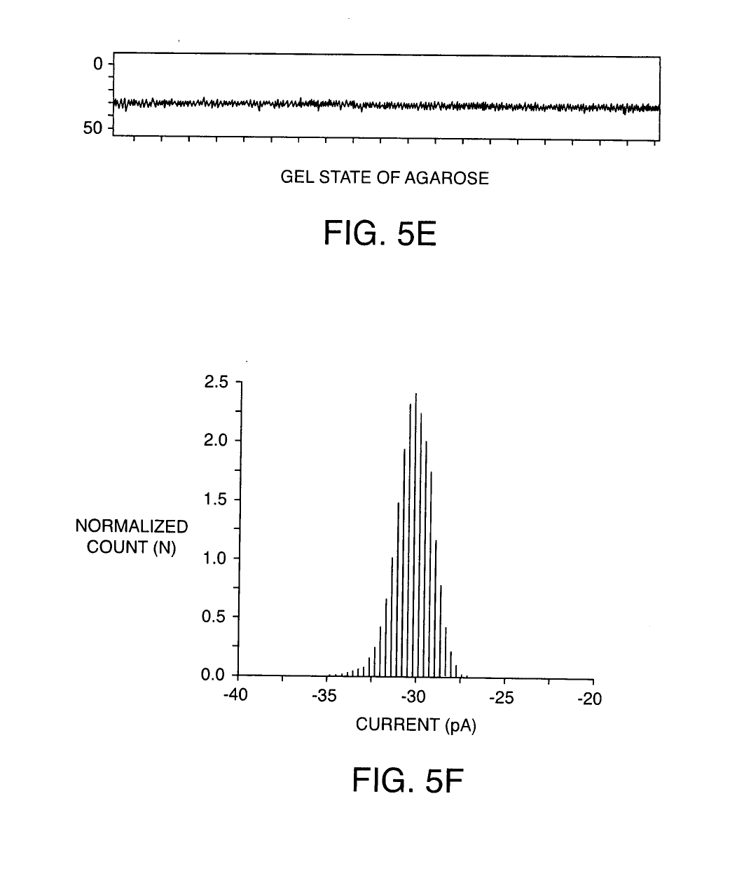

Channel protein (alpha HL) is added to the cis side of the chamber, which is held at ground. A positive potential indicates a higher potential in the trans side of the chamber, and a positive current is one in which cation flow from the trans to the cis side. With respect to the alpha HL protein, the cap domain is exposed to the cis side, while the entrance to the transmembrane beta barrel at the tip of the stem domain is exposed to the trans side. After a single pore has inserted in to the bilayer as detected by electrical recordings, the chambers are cooled so that the agarose gels (FIG. 4).

The gel is cut out of both chambers, leaving a protective layer of agarose in the larger diameter (0.2 cm) opening. The gel-protected sandwich protein channel chip may be removed from the chamber. The central region of the chip containing the 0.2-cm aperture is protected with an adhesive strip and stored at 4 C. To reuse the chip, the seal is removed and the chip is replaced in the chamber. A solution of NaCl (1 M) and 0.1 M Tris buffer (pH 7.4) is added to each side of the chamber before current recording.

### Example 2

### Engineered Alpha-HL Protein Pores

Wild-type alpha HL pores were formed by treating monomeric alpha HL purified from Staphylococcus aureus with deoxycholate as described in Bhakdi et al., Proc. Natl. Acad. Sci. USA 78, 5475-5479 (1981) hereby incorporated by reference. Heptamers were isolated from SDS-polyacrylamide gels as described in Braha et al., Chem. Biol. 4, 497-505 (1997) hereby incorporated by reference. Alpha HL-M113R/T147R (_{PRR-2}) with an internal ring of 14 arginine residues is an engineered pore with high affinities for phosphate esters as described in Cheley et al., Chemistry & Biology, Vol. 9, 829-838, July, 2002, and Cheley et al, Protein Sci. 8, 1257-1267 (1999).

### Example 3

### Sensing Inositol 1,4,5-Triphosphate (IP₃)

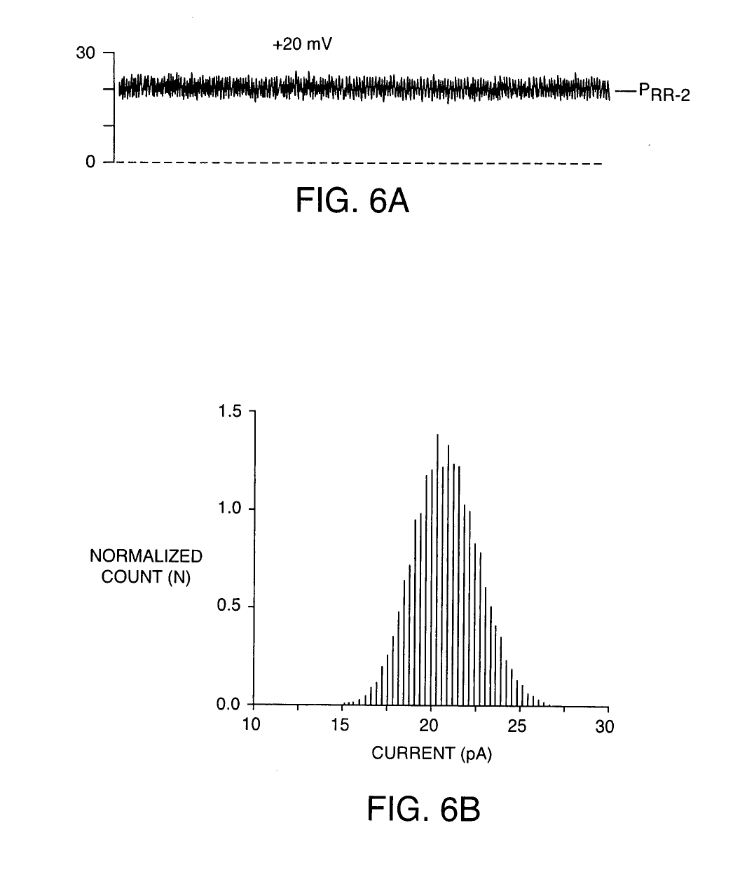

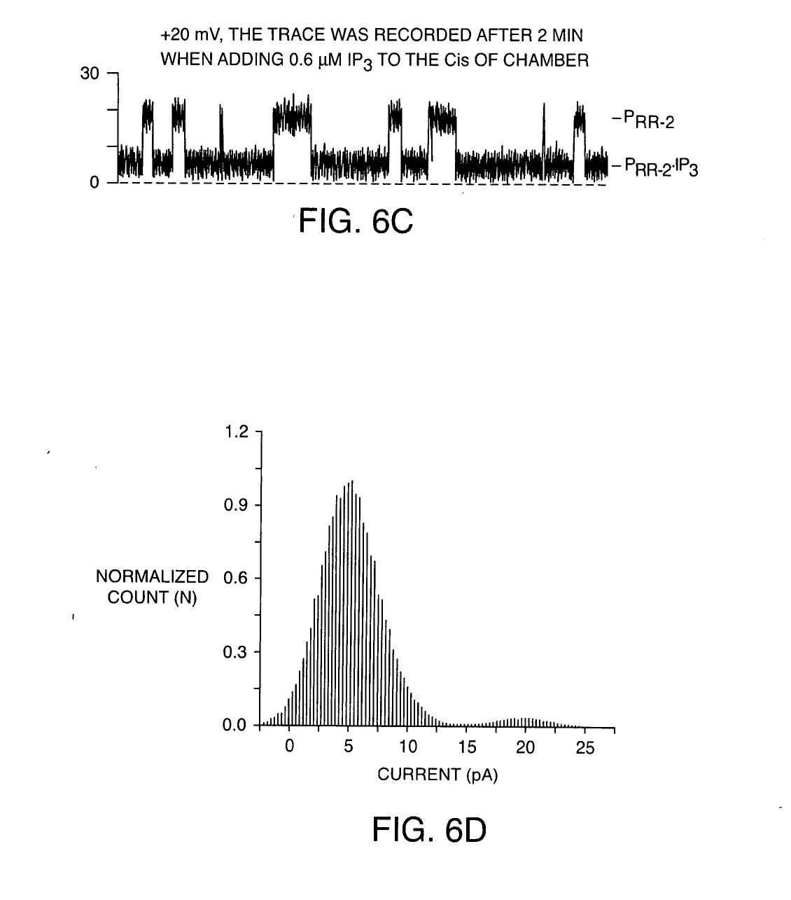

A single M113R/T147 protein was incorporated into the chip structure using the method described in Example 1. After storage for 3 weeks at 4° C., the chips were reassembled in the chamber. The presence of the single channel protein was verified by measuring electrical current of the system. After adding 0.6 μM IP₃ to the cis side of the chamber, the current was interrupted correlating to interaction of the channel protein with IP₃ (see FIG. 6).

1. A device comprising a lipid membrane comprising a single nanopore and a gel configured to surround said lipid membrane.

2. A substrate comprising a middle layer sandwiched between two outer layers; wherein said middle layer comprises an inner orifice containing a lipid membrane comprising a nanopore surrounded by a gel and said two outer layers both comprise outer orifices configured to surround said lipid membrane with said gel.

3. The substrate in claim 2, wherein said lipid membrane consists of a single nanopore.

4. The substrate in claim 2, wherein said nanopore is an alpha HL protein.

5. The substrate in claim 4, wherein said alpha HL protein is alpha HL-M113R/T147R (_{PRR-2}).

6. The substrate in claim 2, wherein said lipid membrane is a phospholipid bilayer.

7. The substrate in claim 6, wherein said phospholipid bilayer comprises 1,2-diphytanoyl-sn-glycero-3-phosphatidylcholine.

8. The substrate in claim 2, wherein said middle layer is polytetrafluoroethylene.

9. The substrate in claim 2, wherein said gel is a polysaccharide based gel.

10. The substrate in claim 9, wherein said polysaccharide based gel comprises agarose and chitosan.

11. A method of creating a gel covered lipid membrane on a substrate comprising:
a) providing:
i) a substrate comprising a first orifice, a first side, and a second side;
ii) a solution having a surface and a first temperature comprising a component for making a gel; and
iii) a lipid;
b) contacting said lipid and said solution under conditions such that said lipid is floating on the surface of said solution; and
c) contacting said first orifice with said lipid under conditions such that a lipid membrane is formed inside said first orifice between said first side and said second side of said substrate and said solution surrounds said lipid; and
d) modifying said solution under conditions such that said component for making a gel forms a gel.

12. The method of claim 11, further comprising the steps of e) adding a nanopore to said solution; and f) applying a voltage between said lipid membrane under conditions such that a lipid membrane comprising said nanopore is formed.

13. The method of claim 11, wherein modifying said solution under conditions such that said component for making a gel forms a gel is cooling said solution to a second temperature below said first temperature.

14. The method of claim 11, wherein said lipid membrane consists of a single nanopore.

15. The method of claim 11, wherein nanopore is an alpha HL protein.

16. The method of claim 15, wherein said alpha HL protein is alpha HL-M113R/T147R (_{PRR-2}).

17. The method of claim 11, wherein said lipid membrane is a phospholipid bilayer.

18. The method of claim 17, wherein said phospholipid bilayer comprises 1,2-diphytanoyl-sn-glycero-3-phosphatidylcholine.

19. The method above, wherein said gel component is agarose or chitosan.

20. A method of detecting an analyte comprising:
a) contacting the device of claim 1 with a solution suspected of containing an analyte,
b) measuring electrical properties, and
c) correlating changes of electrical properties to the existence of an analyte.
